(19) United States
(12) Patent Application Publication
(10) Pub. No.: US 2011/0093880 A1
(43) Pub. Date: Apr. 21, 2011

(54) APPARATUS AND METHOD OF PROVIDING AN INTEGRATED RICH MEDIA ENVIRONMENT

(75) Inventors: Toni Juhani Paila, Helsinki (FI); Topi-Oskari Pohjolainen, Helsinki (FI)

(73) Assignee: Nokia Corporation, Espoo (FI)

(21) Appl. No.: 12/918,975

(22) PCT Filed: Feb. 19, 2009
(86) PCT No.: PCT/FI2009/050135

§ 371 Date: Nov. 29, 2010

Related U.S. Application Data
(60) Provisional application No. 61/030,867, filed on Feb. 22, 2008.

(51) Int. Cl. H04N 5/445; H04N 7/16

(52) U.S. Cl. 725/25; 725/40; 725/48

(57) ABSTRACT

An approach for providing an integrated rich media environment is disclosed. A platform determines to generate metadata relating to media content. The metadata includes a parameter specifying rich media information. The platform also determines to incorporate the metadata into a service guide.

### RELATED APPLICATIONS

This application is a national phase application of PCT Application Serial No. PCT/FI2009/050135, filed Feb. 19, 2009, and claims priority to U.S. Provisional Application Ser. No. 61/030,867, filed Feb. 22, 2008, the entire contents of which are incorporated herein by reference.

### BACKGROUND

Rapid developments in wireless communications, media broadcasting, and content distribution continue facilitating the delivery of various services and products to mobile devices. To promote greater adoption, the telecommunication industry, from manufacturers to service providers, has agreed to develop standards for communication protocols that underlie the various services and features. One area of effort involves the integration of rich media (e.g., graphics, text, video, and audio) into existing services such as mobile television (TV). Mobile TV, in particular, is suitable for integration with rich media because the service involves delivery of various entertainment content and services to mobile users, allowing personalized and interactive viewing of TV content that is specifically adapted for the mobile medium. However, such integration is challenging in view of the variety of formats and delivery mechanisms for rich media and the mobile TV service.

### SOME EXEMPLARY EMBODIMENTS

Therefore, there is a need for an approach for providing an integrated rich media environment that can co-exist with already developed standards and protocols.

According to one embodiment, a method comprises determining to generate metadata relating to media content. The metadata includes a parameter specifying rich media information. The method also comprises determining to incorporate the metadata into a service guide.

According to yet another embodiment, an apparatus comprising at least one processor, and at least one memory including computer program code, the at least one memory and the computer program code configured to, with the at least one processor, cause, at least in part, the apparatus to determine generate metadata relating to media content. The metadata includes a parameter specifying rich media information. The apparatus is also caused to determine to incorporate the metadata into a service guide.

According to another embodiment, a computer-readable storage medium carries one or more sequences of one or more instructions which, when executed by one or more processors, cause, at least in part, an apparatus to determine to generate metadata relating to media content. The metadata includes a parameter specifying rich media information. The apparatus is also caused to determine to incorporate the metadata into a service guide.

According to another embodiment, an apparatus comprises means for determining to generate metadata relating to media content. The metadata includes a parameter specifying rich media information. The apparatus also comprises means for determining to incorporate the metadata into a service guide.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing an integrated rich media environment, according to an exemplary embodiment;

FIG. 2 is a diagram of the fragments of a service guide, according to an exemplary embodiment;

FIG. 3 is a flowchart of processes for providing an integrated rich media environment, according to an exemplary embodiment;

FIG. 4 is a diagram of paths for transmitting a service guide to a user equipment, according to an exemplary embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile station (e.g., handset) that can be used to implement an embodiment of the invention.

### DESCRIPTION OF PREFERRED EMBODIMENT

An apparatus, method, and software for providing an integrated rich media environment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to integrating rich media with a mobile television (TV) service, it is recognized by one of ordinary skill in the art that the embodiments of the inventions have applicability to any type of service that is compatible with rich media.

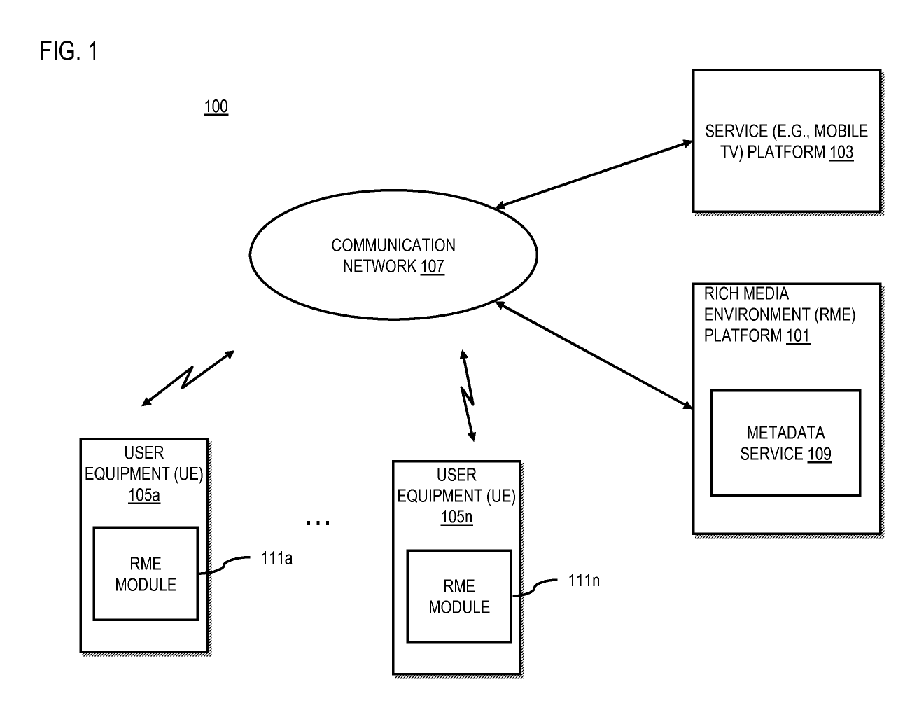

FIG. 1 is a diagram of a communication system capable of providing an integrated rich media environment, according to an exemplary embodiment. As shown in FIG. 1, a system 100 comprises a rich media environment (RME) platform 101 having connectivity to a service platform 103 (e.g., a mobile TV service platform) and one or more user equipment (UEs) (e.g., UEs 105a-105n) via a communication network 107. In exemplary embodiments, the RME platform 101, in conjunction with the service platform 103 enables the integration of rich media (e.g., content containing multiple media types or providing interactivity) with the service (e.g., mobile TV service) provided by the service platform 103. Although depicted as separate components, the RME platform 101 and the service platform 103, in certain embodiments, may be combined in one platform or included in other network components.

The UEs 105a-105n are any type of fixed terminal, mobile terminal, or portable terminal including desktop computers, laptop computers, handsets, stations, units, devices, multimedia tablets, Internet nodes, communicators, Personal Digital Assistants (PDAs), or any combination thereof. It is also contemplated that the UEs 105a-105n can support any type of interface to the user (such as “wearable” circuitry, etc.). The UEs 105a-105n, for instance, enable user access to the services of the RME platform 101 and the service platform 103.

By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

As discussed previously, the telecommunication industry has agreed to develop standards and protocols to support mobile services and features. As part of this effort, the Open Mobile Alliance (OMA) has lead the work on defining a global standard to enable interoperable mobile data services that work across devices, service providers, operators, networks, and geographies. OMA's goal has been to develop mobile service enabler specifications, which support the creation of interoperable end-to-end mobile services, and to drive service enabler architectures and open enabler interfaces that are independent of the underlying wireless networks and platforms.

To this end, the OMA has developed the Mobile Broadcast Services Enabler Suite (BCAST) to define the specifications and functions for mobile broadcast services. OMA BCAST is a bearer agnostic application layer for broadcast services that specifies a framework for describing the services as well as necessary protocols to deliver the content. It also specifies a framework for declaring interaction methods, and associating and scheduling those methods with broadcast content. OMA BCAST consists of several functions such as service guide, content protection, interaction, purchase and payment, file delivery, and service provisioning.

Of these functions, the service guide is one the most important because the guide enables content providers to describe the available services and contents, and how to access such services and contents. From a user's point of view, the Service Guide is an entry point to a wide range of available or scheduled services, including, but not limited to, the various interactive services that are available on the mobile network. The development of the mobile broadcast infrastructure has also spurred the demand for rich media content. Rich media generally refers to content that is graphically rich and contains compound (or multiple) media, including graphics, text, video and audio. For example, rich media ranges from a movie enriched with vector graphics overlays and interactivity (possibly enhanced with closed captions), to complex multi-step services with fluid interaction and different media types at each step.

However, the current mobile broadcast infrastructure (e.g., OMA BCAST) does not support scene descriptions and layouts as they relate to the delivery of rich media services. Therefore, integration of rich media services with a mobile TV service using, for instance, OMA BCAST, is challenging. To address this problem, the RME platform 101 enables the integration of metadata specifying rich media information (e.g., including rich media content) in content descriptors of existing mobile broadcast protocols (e.g., OMA BCAST service guide).

More specifically, in exemplary embodiments, the RME platform 101 includes a metadata service 109 for generating metadata relating to media content offered by, for instance, a mobile TV service of service platform 105. The metadata includes one or more parameters specifying rich media information associated with the media content. By way of example, the media content includes broadcast television programming, on-demand programming, pay-per-view programming, Internet-based programming, personalized content delivery, interactive programming, or any combination thereof. Additionally, the rich media information includes one or more rich media components such as video, audio, text, and/or other multimedia content supporting, for instance, scene descriptions and layout. The RME platform 101 transmits this metadata to the UEs 105a-105n by appending the metadata to elements of the existing protocol (e.g., OMA BCAST) such as the service guide delivery descriptor, one or more fragments of the service guide, an interaction channel, or one or more entry points of broadcast channel.

In exemplary embodiments, the UEs 105a-105n include an RME module 111 to decode the RME metadata and access the rich media information associated with the media content of the mobile TV service.

As shown in FIG. 1, the mobile TV service can be provided by, for instance, the service platform 103. By way of example, the service platform 103 uses a broadcast model that distributes media content over two channels to the UEs 105a-105n over communication network 107. The two channels include a unidirectional broadcast channel (realized, for example, with digital video broadcasting-handheld (DVB-H), multimedia broadcast multicast service (MBMS), and the like) and a bi-directional interactive channel (realized for example, with wireless local area network (WLAN), worldwide interoperability for microwave access (WiMAX), long term evolution (LTE), and the like). The broadcast channel enables the transmission of the main content such as, multimedia files or streams, and the interactivity content, as well as the delivery of electronic service guides, software updates and other suitable services. The content may be delivered over the Broadcast Channel using, for example, Real Time Transport (RTP), File Delivery over Unidirectional Transport (FLUTE), Hyper Text Transfer Protocol (HTTP), or similar transport protocols. The interactive channel may be used for user feedback, personalized content requests, purchasing and payments, and other suitable services.

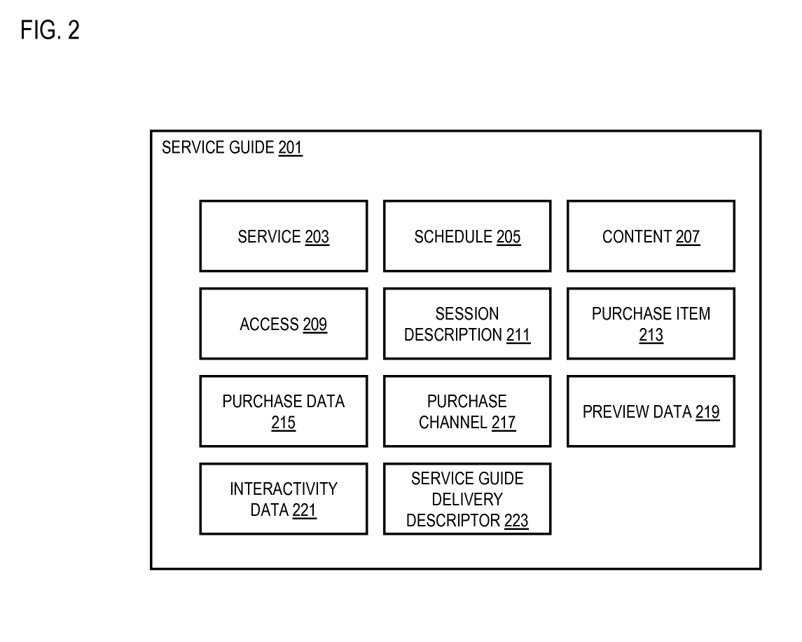

FIG. 2 is a diagram of the fragments of a service guide, according to an exemplary embodiment. The OMA BCAST service guide 201 provides information and framework for the discovery and access to content and services provided over either the broadcast or interactive channels. The OMA BCAST service guide 201 also specifies a framework for declaring interaction methods, and associating and scheduling those methods with the broadcast content. Specifically, The OMA BCAST service guide 201 models the services, schedules, content, related purchase and provisioning data, and interactivity data in terms of service guide fragments. A fragment is an information component of the service guide, which can be compressed, encapsulated and transported in the absence of other parts of the service guide. These fragments contain metadata and information regarding available services in, for instance, extensible markup language (XML) format. In exemplary embodiments, the extensibility of the service guide is used to incorporate rich media information into fragments of the service guide 201.

The fragments defined in the OMA BCAST service guide are: Service 203, Schedule 205, Content 207, Access 209, SessionDescription 211, Purchaseltem 213, PurchaseData 215, PurchaseChannel 217, PreviewData 219, InteractivityData 221, and ServiceGuideDeliveryDescriptor 223. Each fragment may comprise a plurality of elements and attributes that are further characterized in terms of their type, cardinality, category, description, and data type. Some of the functionalities of the various fragments are summarized below.

The Service fragment 203 describes, at an aggregate level, the content items which comprise a broadcast service. The service may be delivered to the user using multiple means of access, for example, via the broadcast channel and the interactive channel. The service may be targeted at a certain user group or geographical area. Depending on the type of the service, it may have interactive part(s), broadcast-only part(s), or both. Further, the service may include components not directly related to the content but to the functionality of the service—such as purchasing or subscription information. As the part of the service guide 201, the Service fragment 203 forms a central hub referenced by the other fragments including Schedule 205, Content 207, Access 209, and PurchaseItem 213 fragments.

The Schedule fragment 205 defines the timeframes in which associated content items are available for streaming, downloading and/or rendering. This fragment 205 references the Service fragment 203. It may also reference one or more Content fragments 207 or InteractivityData fragments 221, in which case, it defines the valid distribution and/or presentation timeframe of those content items belonging to the service, or the valid distribution timeframe and the automatic activation time of the InteractivityMediaDocuments (IMD) associated with the service.

The Content fragment 207 provides a detailed description of a specific content item. In addition to defining a type, description, and language of the content, the fragment 207 may provide information regarding the targeted user group or geographical area, as well as genre and parental rating.

The Access fragment 209 describes how the service may be accessed during the lifespan of the service. This fragment 209 contains or references Session Description information and indicates the delivery method. One or more Access fragments 209 may reference a Service fragment 203, offering alternative ways for accessing or interacting with the associated service.

The SessionDescription fragment 211 is a service guide fragment that provides the session information for access to a service or content item. The fragment 211 may further provide auxiliary description information that is used for associated delivery procedures.

The PurchaseItem fragment 213 represents a group of one or more services (i.e. a service bundle) or one or more content items, offered to the end user for free, for subscription and/or for purchase.

The PurchaseData fragment 215 is another service group fragment that expresses all the available pricing information about the associated purchase item.

The PurchaseChannel fragment 217 carries the information regarding the entity from which purchase of access and/or content rights for a certain service, service bundle or content item may be obtained, as defined in the PurchaseData fragment 215.

The PreviewData fragment 219 contains information that is used by the UE 105 to present the service or content outline to users. The PreviewData fragment 219 can include simple texts, static images (for example, logo), or short video clips. The fragment 219 can also reference another service that could be a low bit rate version for the main service.

The InteractivityData fragment 221 contains information that is used by the UE 105 to offer interactive services to the user, which is associated with the broadcast content. These interactive services enable users to, for example, vote during TV shows or obtain content related to the broadcast content. The InteractivityData fragment 221 points to one or more InteractivityMediaDocuments (IMD) that may include, for example, files, static images, email template, short message service (SMS) template, multimedia messaging service (MMS) template documents, and the like.

The ServiceGuideDeliveryDescriptor (SGDD) 223 is transported on the Service Guide Announcement Channel, and informs the UE 105 of the availability, metadata, and grouping of the fragments of the service guide 201. The SGDD 223 enables quick identification of the service guide fragments that are either cached in the UE 105 or being transmitted by the service platform 103. It also provides the grouping of related Service Guide fragments and thus a means to determine completeness of such group.

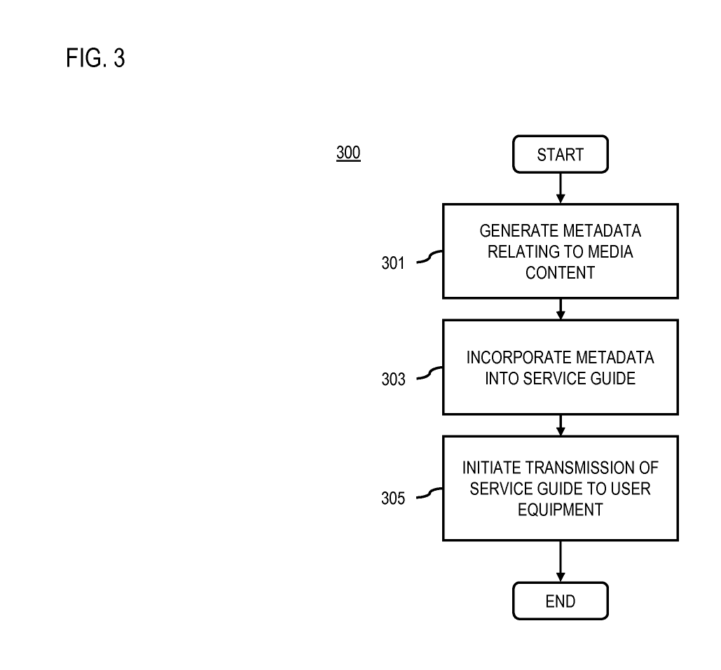

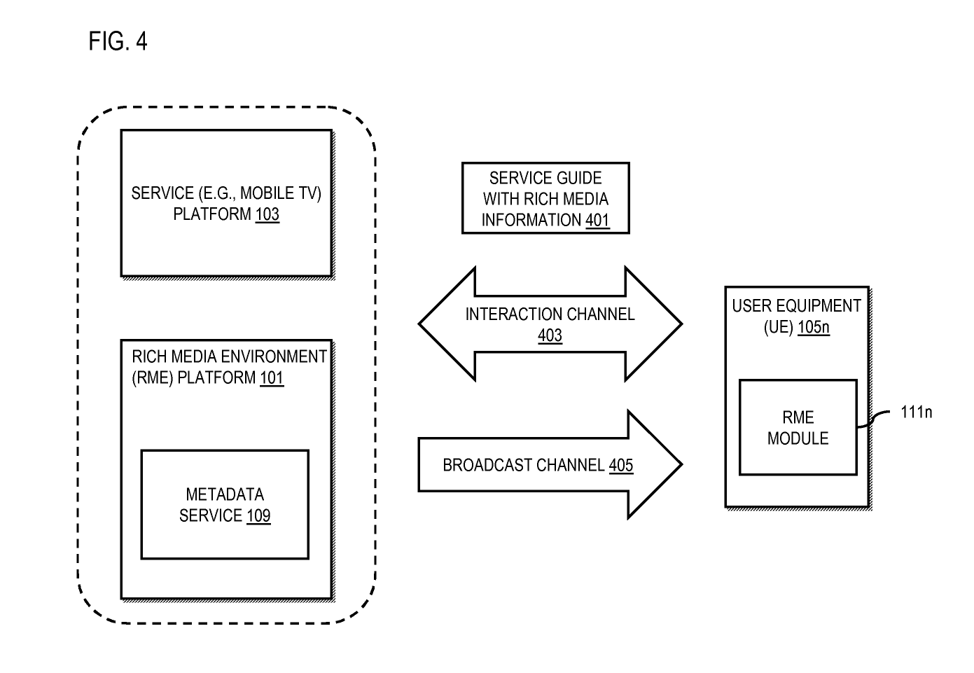

FIG. 3 is a flowchart of processes for providing an integrated rich media environment, according to an exemplary embodiment. In one embodiment, the metadata service 109 of the RME platform 101 performs the process 300 and is implemented in, for instance, a chip set including a processor and a memory as shown FIG. 4. In step 301, the metadata service generates metadata relating to the media content of the mobile TV service of service platform 103. In exemplary embodiments, the metadata specifies rich media information associated with a particular mobile TV program. This rich media information includes, for instance, one or more rich media components using any one of the several existing or future technologies, such as scalable vector graphics (SVG), Adobe Flash®, synchronized multimedia integration language (SMIL), MPEG-4 lightweight application scene representation (LASeR), OMA rich media environment (OMA RME), and other techniques and systems (hereinafter collectively referred to as RME).

In exemplary embodiments, the metadata service 109 incorporates the RME metadata in the OMA BCAST service guide 201. As part of the service guide 201, the RME metadata provide an additional layout component to the OMA BCAST service guide 201. It is also contemplated that the RME metadata can be an alternative or addition to the OMA BCAST service guide 201. Additionally, the rich media information in the RME metadata may be provided in such a way so that the RME metadata are ignored by a UE 105 employing legacy technology (i.e., not including an RME module 111 or otherwise incompatible). In this way, the metadata service 109 maintains backwards compatibility with UEs 105 unable to receive rich media information (i.e., incompatible user equipment).

By way of example, the metadata service 109 appends the generated RME metadata to the fragments and/or protocols of the OMA BCAST service guide 201 using the extension method provided by the service guide (step 303). For example, in one embodiment, the RME metadata may be utilized for describing the layout/scene as a full alternative to the service guide. This embodiment may be effected by modifying the SGDD 223, or by providing a new bootstrap message that instead of pointing to the SGDD 223, points to an RME resource. For example, the message may point to a broadcast stream that carries one or more RME descriptions and/or updates, or to one or more Uniform Resource Identifiers (URI) to access and retrieve the RME components. In another embodiment, the RME metadata may be used for describing the layout/scene of a Service fragment 203 or Content fragment 207 of the service guide 201. In yet another embodiment, the RME metadata may be provided as an additional component of the Access fragment 209 and/or SessionDescription fragment 211 of the service guide 201. In a further embodiment, when a service interaction is declared in the service guide 201, the RME metadata may be provided as an alternative to using the Interactivity Media Document (IMD) framework. These and other embodiments provide, for instance, a migration path from the provisioned mobile broadcast services towards a more flexible web-oriented architecture.

By way of example, the metadata service 111 may modify any combination of the OMA BCAST service guide fragments to contain the RME metadata. These various combinations of amendments provide many, and possibly overlapping, methods for incorporating the RME metadata into the service guide 201. To facilitate description of these methods and modifications, certain embodiments are described with the aid of Tables 1-11. Within the tables, the modifications in accordance with the embodiments are illustrated using underlined text. Six table headings are used to describe each table entry: Name, Type, Category, Cardinality, Description, and Data Type. “Name” represents the names of elements and attributes associated with a particular fragment of the Service Guide. “Type” indicates whether the entry is an Element (E) or an Attribute (A). The elements can have values E1, E2, E3 and E4, represented according to their hierarchy. Specifically, E1 represents an element with the highest order of hierarchy, E2 indicates a sub-element of E1, E3 indicates a sub-element of E2, and E4 indicates a sub-element of E3. “Category” designates whether the corresponding element or attribute is Mandatory (M) or Optional (O), in the Network (N) (e.g., service platform 103) or the Terminal (T) (e.g., UE 105). Thus, for example, “TM” is used to designate a “terminal mandatory” category. “Cardinality” indicates the relationship between the elements, with “0” designating an optional relationship, “1” representing a mandatory relationship, and “N” designating that a plurality of values may be used. “Description” provides the description of the corresponding element or attribute, and “Data Type” represents the data type of the corresponding element or attribute.

Table 1 represents an embodiment in which the Service fragment 203 of the service guide 201 is amended to include the RME metadata. This amendment is effected by defining a new type having an exemplary value “10” designating a service for which layout/scene description associated with the RME is delivered within the default access fragment. The new service type (“10”) may be combined with other service types. For example, the combination of service types 1 and 10 may designate Basic TV for which the RME metadata are given as default access for the service.

TABLE 1
Exemplary Service Fragment

| Name | Type | Category | Cardinality | Description | Data Type |
|---|---|---|---|---|---|
| ServiceType | E1 | NM/TM | 0 . . . N | Type of the service. | unsigned |
| | | | | Allowed values are: | Byte |
| | | | | 0 - unspecified | |
| | | | | 1 - Basic TV | |
| | | | | 2 - Basic Radio | |
| | | | | 3 - RI services | |
| | | | | 4 - Cachecast | |
| | | | | 5 - File download services | |
| | | | | 6 - Software management services | |
| | | | | 7 - Notification | |
| | | | | 8 - Service Guide | |
| | | | | 9 - Terminal Provisioning services | |
| | | | | 10 - Service for which layout/scene | |
| | | | | description is delivered within the default | |
| | | | | Access fragment 209 | |
| | | | | 11-127 reserved for future use | |
| | | | | 128-255 reserved for proprietary use | |
| | | | | The mixed service types are indicated by the | |
| | | | | presence of multiple instances of ServiceType | |
| | | | | (for example, for mixed Basic TV and | |
| | | | | Cachecast, two instances of ServiceType, | |
| | | | | with values 1 and 4 are present for this | |
| | | | | ‘Service’ fragment. | |
| | | | | This element is processed by the terminal | |
| | | | | strictly for rendering to the user for example | |
| | | | | as a textual indicator, an icon, or graphic | |
| | | | | representation for the service. However, | |
| | | | | ‘ServiceType’ with value of 3 and 9 need not | |
| | | | | be rendered and their existence need not be | |
| | | | | displayed to the user. | |
| | | | | With value 6, i.e. software management | |
| | | | | services, users can select the desired software | |
| | | | | components (e.g. desktop theme, ringtone, SG | |
| | | | | navigator update) to download over broadcast | |
| | | | | channel or interaction channel. The software | |
| | | | | components provided by this software | |
| | | | | management service are described by | |
| | | | | ‘Content’ fragments 207 which belong to this | |
| | | | | ‘Service’ fragment 203. It is not expected that | |
| | | | | terminals are able to automatically select and | |
| | | | | download software components using this | |
| | | | | type of service. | |

In accordance with another embodiment, as illustrated in Table 2, the Service fragment 203 may be amended with a new subelement (E1) “RmeAccessRef.” This subelement is a reference to the Access fragment that declares access to RME layout/scene descriptions and/or updates—for example, a broadcast Real-Time Protocol (RTP) stream. This subelement may use the inherent XML schema extension method that is used in the BCAST service guide 201.

TABLE 2
Exemplary Service Fragment

| Name | Type | Category | Cardinality | Description | Data Type |
|---|---|---|---|---|---|
| RmeAccess | E1 | NO/TO | 0 . . . N | Reference to Access fragment 209 that | |
| Ref | | | | declares access to RME scene | |
| | | | | descriptions and scene updates, e.g., | |
| | | | | broadcast RTP stream carrying those. | |

In accordance with another embodiment, as illustrated in Table 3, the Content fragment 207 may be amended with a new subelement (E1) “RmeAccessRef” that is a reference to the Access fragment that declares access to RME scene descriptions and scene updates—for example, a broadcast Real-Time Protocol (RTP) stream. This subelement uses inherent XML schema extension method of BCAST service guide 201.

TABLE 3
Exemplary Content Fragment

| Name | Type | Category | Cardinality | Description | Data Type |
|---|---|---|---|---|---|
| RmeAccessRef | E1 | NO/TO | 0 . . . N | Reference to access fragment that declares access to | |
| | | | | RME scene descriptions and scene updates, for | |
| | | | | example, broadcast RTP stream carrying those. | |

In the BCAST service guide 201, the Access fragment 209 comprises subelement (E1) “AccessType,” which defines the type of access to broadcast according to subelement (E2) “BroadcastServiceDelivery,” and to unicast delivery according to subelement (E2) “UnicastServiceDelivery.” These subelements may further comprise another subelement (E3) “SessionDescription,” comprising another subelement (E4) “SDP” that represents inlined Session Description fragment 211 in session description protocol (SDP) format. According to another embodiment, as illustrated in Table 4A, if the RME components are used for scene/layout descriptions/updates, subelement “SDP” may further contain, in addition to A/V stream declarations, a declaration corresponding to the RME stream, which for example, may be similar to the one defined for the 3rd Generation Partnership Project dynamic and interactive multimedia scenes (3GPP DIMS).

TABLE 4A
Exemplary Access Fragment

| Name | Type | Category | Cardinality | Description | Data Type |
|---|---|---|---|---|---|
| SDP | E4 | NM/TM | 0 . . . 1 | An inlined Session Description 211 in SDP | string |
| | | | | format [RFC 4566] that can either be | |
| | | | | embedded in a CDATA section or base64- | |
| | | | | encoded. | |
| | | | | In case RME is used for scene/layout | |
| | | | | descriptions/updates, the SDP can contain, in | |
| | | | | addition to A/V stream declarations, a | |
| | | | | declaration of RME stream, for example like | |
| | | | | defined for 3GPP/DIMS. | |
| | | | | Contains the following attribute: | |
| | | | | encoding | |

Furthermore, the same subelement (E3) “SessionDescription” of the Access fragment 209 may comprise another subelement (E4) “SDPRef” that is a reference to a Session Description fragment 211 in SDP format. According to an embodiment, as illustrated in Table 4B, in cases where RME is used for scene/layout descriptions/updates, the referenced SDP may contain, in addition to A/V stream declarations, a declaration of an RME stream, which for example, may be similar to the one defined for 3GPP/DIMS.

TABLE 4B
Exemplary Access Fragment

| Name | Type | Category | Cardinality | Description | Data Type |
|---|---|---|---|---|---|
| SDPRef | E4 | NM/TM | 0 . . . 1 | Reference to a Session Description 211 in SDP | |
| | | | | format [RFC 4566] | |
| | | | | Contains the following attributes: | |
| | | | | uri | |
| | | | | idRef | |
| | | | | If both ‘uri’ and ‘idRef’ are present, the | |
| | | | | referenced Session Description information is | |
| | | | | identical. | |
| | | | | In case RME is used for scene/layout | |
| | | | | descriptions/updates, the SDP can contain, in | |
| | | | | addition to A/V stream declarations, a | |
| | | | | declaration of RME stream, for example like | |
| | | | | defined for 3GPP/DIMS. | |

In accordance with another embodiment, as illustrated in Table 5, a new service class for scene description/layout and their updates may be defined for the Access fragment 209. This service class may be called “urn:oma:bcast:oma_bsc:rme:1.0” for both scene description/layout and their updates.

In another embodiment, also illustrated in Table 5, two separate service classes may be defined; one for only descriptions/layouts, called “urn:oma:bcast:oma_bsc:layout:1.0,” and another for their updates, called “urn:oma:bcast:oma_bsc:layout update:1.0.”

In a further embodiment, also illustrated in Table 5, an additional service class, may be defined to indicate that a particular Access fragment 209 declares access parameters to the referred service guide 201 that is not delivered as service guide fragments, but as an RME session.

TABLE 5
Exemplary Access Fragment

| Name | Type | Category | Cardinality | Description | Data Type |
|---|---|---|---|---|---|
| ServiceClass | E1 | NM/TM | 1 . . . N | The ServiceClass identifies the class of service. | string |
| | | | | This identification is more detailed than the | |
| | | | | ‘ServiceType’ element in the ‘Service’ fragment | |
| | | | | 203 and allows the association of service/access | |
| | | | | combination to specific applications. | |
| | | | | The Terminal is able to interpret the | |
| | | | | ServiceClasses as defined in OMNA registry (see | |
| | | | | Appendix E). | |
| | | | | BCAST defines a new ServiceClass called | |
| | | | | “urn:oma:bcast:oma_bsc:rme:1.0” for both scene | |
| | | | | description/layouts s and their updates, or two | |
| | | | | separate ServiceClasses | |
| | | | | “urn:oma:bcast:oma_bsc:layout:1.0” (for layouts | |
| | | | | only) and | |
| | | | | “urn:oma:bcast:oma_bsc:layout_update:1.0” (for | |
| | | | | updates only). | |
| | | | | Further, additional ServiceClass called | |
| | | | | “urn:oma:bcast:oma_bsc:rme-sg:1.0” can be used | |
| | | | | to signal that this Access fragment declares access | |
| | | | | parameters to referred Service Guide 201 which is | |
| | | | | not delivered as BCAST SG Fragments but as | |
| | | | | RME session. | |

In accordance with another embodiment, as illustrated in Table 6, a new subelement (E1) “RMEReception” may be defined for the Access fragment. This subelement may declare reception information for service-specific RME scene/layout descriptions and/or updates. In addition, subelement (E2) “IPBroadcastDelivery,” attribute (A) “port,” attribute (A) “address,” subelement (E2) “RequestURL,” and subelement (E2) “PollURL” may be defined. Table 6 provides further details for describing the above elements and attributes. Furthermore, subelement (E1) “TerminalCapabilityRequirement,” in the Access fragment 209 may be amended with one or more subelements and/or attributes thereto for RME described reception of fragments or service guide 201.

TABLE 6
Exemplary Access Fragment

| Name | Type | Category | Cardinality | Description | Data Type |
|---|---|---|---|---|---|
| RmeReception | E1 | NO/TM | 0 . . . 1 | Reception information for | |
| | | | | service-specific RME | |
| | | | | scene/layout descriptions and/or | |
| | | | | updates | |
| | | | | Contains the following elements: | |
| | | | | IPBroadcastDelivery | |
| | | | | RequestURL | |
| | | | | PollURL | |
| IPBroadcastDelivery | E2 | NM/TM | 0 . . . 1 | Provides IP multicast address and | |
| | | | | port number for reception of | |
| | | | | RME scene descriptions and | |
| | | | | updates over the broadcast | |
| | | | | channel. | |
| | | | | In case the ‘address’ attribute is | |
| | | | | not provided the destination | |
| | | | | address provided by this access | |
| | | | | fragment is assumed. | |
| | | | | Contains the following attributes: | |
| | | | | port | |
| | | | | address | |
| Port | A | NM/TM | 1 | Service-specific RME delivery | unsignedInt |
| | | | | UDP destination port number. | |
| | | | | delivery over broadcast channel. | |
| Address | A | NM/TM | 0 . . . 1 | Service-specific RME delivery IP | string |
| | | | | multicast address, delivery over | |
| | | | | broadcast channel. | |
| RequestURL | E2 | NM/TM | 0 . . . 1 | URL through which the terminal | anyURI |
| | | | | can subscribe to service-specific | |
| | | | | RME messages. | |
| PollURL | E2 | NM/TM | 0 . . . 1 | URL through which the terminal | anyURI |
| | | | | can poll service-specific RME | |
| | | | | messages. | |

In accordance with another embodiment, as illustrated in Table 7, PreviewData fragment 219 may be amended so that subelement (E1) “AccessReference” comprises a new value for attribute (A) “usage.” This value, which is set to “2,” may indicate that preview data stream is actually carrying scene/layout descriptions and/or updates.

TABLE 7
Exemplary PreviewData Fragment

| Name | Type | Category | Cardinality | Description | Data Type |
|---|---|---|---|---|---|
| usage | A | NM/TM | 1 | Usage of the ‘Access’ fragment 209 | unsignedByte |
| | | | | identified by ‘AccessReference’ element. | |
| | | | | Allowed value: | |
| | | | | 0. Indicates that the preview data files | |
| | | | | referenced by VideoURI, AudioURI or | |
| | | | | PictureURI can be accessed from a file | |
| | | | | distribution session, whose distribution | |
| | | | | scheduling is signaled by Session Description | |
| | | | | embedded in or referenced by the ‘Access’ | |
| | | | | fragment 209 | |
| | | | | 1. Indicates that the preview data stream can | |
| | | | | be accessed from a stream distribution | |
| | | | | session, whose distribution scheduling is | |
| | | | | signaled by Session Description embedded in | |
| | | | | or referenced by the ‘Access’ fragment 209. | |
| | | | | 2. Indicates that preview data stream is | |
| | | | | actually carrying scene/layout | |
| | | | | descriptions/updates. | |
| | | | | 3-127. reserved for future use | |
| | | | | 128-255. reserved for proprietary use | |

In accordance with another embodiment, as illustrated in Table 8, the “InteractivityData” fragment 221 is amended so that the attribute “usage” corresponding to “InteractivityMediaDocumentPointer” includes a special reserved value “rme.” This special value may be interpreted by the UE 105 as an indication that the associated Access fragment 209 is carrying the scene/layout descriptions and/or updates. The “InteractivityMediaDocumentPointer” is a reference to the group identification (“GroupID”) of the interactivity media documents (“InteractivityMediaDocuments”), which refer to the interactivity media objects. The pointer points to all “InteractivityMediaDocuments” with the same “GroupID.”

TABLE 8
Exemplary InteractivityData Fragment

| Name | Type | Category | Cardinality | Description | Data Type |
|---|---|---|---|---|---|
| InteractivityMe | A | NM/TM | 1 | Reference to the GroupID of the | anyURI |
| diaDocumentP | | | | InteractivityMediaDocuments which | |
| ointer | | | | refer to the interactivity media | |
| | | | | objects. The pointer points to all | |
| | | | | InteractivityMediaDocuments with | |
| | | | | the same GroupID. The | |
| | | | | InteractivityMediaDocument with | |
| | | | | the highest GroupPosition (see | |
| | | | | [BCAST10-Services] section 5.3.6) | |
| | | | | is rendered. | |
| | | | | When multiple ‘InteractivityData’ | |
| | | | | fragments point to the same | |
| | | | | GroupID, this means that the | |
| | | | | InteractivityMediaDocuments | |
| | | | | belonging to this GroupID applies to | |
| | | | | all of these ‘InteractivityData’ | |
| | | | | fragments 221. | |
| | | | | Special value “rme” is RESERVED. | |
| | | | | The terminal can interpret this so | |
| | | | | that the associated access fragment | |
| | | | | 209 carries the scene/layout | |
| | | | | descriptions and/or updates. | |

The “InteractivityData” fragment 221 comprises subelement (E1) “InteractiveDelivery” and attribute (A) “InteractivityMediaURL,” which indicates the URL from which Interactivity Media can be retrieved. In accordance with another embodiment, as illustrated in Table 9, the “InteractivityMediaURL” may be amended to comprise a special value “rme” that is reserved for the prefix of the URI. When this special value is used, the UE 105 may interpret this value as an indication that the URL is pointing to the scene/layout descriptions and/or updates.

TABLE 9
Exemplary InteractivityData Fragment

| Name | Type | Category | Cardinality | Description | Data Type |
|---|---|---|---|---|---|
| InteractivityMediaURL | A | NO/TM | 0 . . . 1 | URL from which Interactivity | anyURI |
| | | | | Media can be retrieved. The | |
| | | | | Content-Type is “multipart/mixed” | |
| | | | | in the HTTP response. | |
| | | | | Special value “rme” is RESERVED | |
| | | | | for the prefix of the URI. When | |
| | | | | used, terminal can interpret this so | |
| | | | | that the URL points to the | |
| | | | | scene/layout descriptions and/or | |
| | | | | updates. | |

In accordance with another embodiment, as illustrated in Table 10, the InteractivityData fragment 221 may be amended to comprise a new subelement (E1) “NoIMD” to indicate that interaction is achieved by using interactive scene/layout descriptions described by RME descriptions instead of using Interactivity Media Documents (IMD). The data type for this subelement may be Boolean as illustrated in Table 10.

TABLE 10
Exemplary InteractivityData Fragment

| Name | Type | Category | Cardinality | Description | Data Type |
|---|---|---|---|---|---|
| NoIMD | E1 | NO/TO | 0 . . . 1 | Indicates that BCAST Interactivity Media | Boolean |
| | | | | Documents are not used but the interaction is | |
| | | | | achieved by interactive scene/layout | |
| | | | | descriptions. | |

In accordance with another embodiment, as illustrated in Table 11, SGDD 223 may be amended to comprise a new subelement (E1) “RmeReception.” This subelement may define reception information for scene/layout descriptions and/or their updates. In case of delivery over the Broadcast Channel, subelement (E2) “IPBroadcastDelivery” may specify the address and port number information for receiving scene/layout descriptions and/or their updates. In case of delivery over the Interaction Channel, subelement (E2) “RequestURL,” of type “anyURI,” may specify address information for subscribing notification, and subelement (E2) “PollURL,” also of type “anyURI,” may specify address information for polling scene/layout descriptions and/or their updates. In one embodiment, wherein the service guide 221 is delivered as RME session, the changes to the service guide are scene updates, and are delivered within the RME delivery channel. Alternatively or additionally, in accordance with another embodiment, as also illustrated in Table 11, subelement (E1) “RmeReception” may also be introduced on “BSMSelector” level in the SGDD 223, thus allowing the delivery of multiple service provider specific RME streams (e.g., different, customized descriptions/updates per provider).

TABLE 11
Exemplary Service Guide SGDD

| Name | Type | Category | Cardinality | Description | Data Type |
|---|---|---|---|---|---|
| RmeReception | E1 | NM/TM | 0 . . . 1 | Reception information for | |
| | | | | scene/layout descriptions and/or | |
| | | | | their updates. | |
| | | | | In case of delivery over Broadcast | |
| | | | | channel, IPBroadcastDelivery | |
| | | | | specifies the address information | |
| | | | | for receiving scene/layout | |
| | | | | descriptions and/or their updates. | |
| | | | | In case of delivery over | |
| | | | | Interaction channel, RequestURL | |
| | | | | specify address information for | |
| | | | | subscribing notification, PollURL | |
| | | | | specify address information for | |
| | | | | polling scene/layout descriptions | |
| | | | | and/or their updates. . | |
| | | | | Contains the following elements: | |
| | | | | IPBroadcastDelivery | |
| | | | | RequestURL | |
| | | | | PollURL | |
| | | | | This alternative enables the | |
| | | | | terminal totally to replace service | |
| | | | | guide with RME scene | |
| | | | | descriptions | |
| | | | | This element can also be | |
| | | | | introduced on BSMSelector level | |
| | | | | enabling to provide multiple, | |
| | | | | Service Provider specific RME | |
| | | | | streams (different, customized | |
| | | | | descriptions/updates per | |
| | | | | provider). | |
| IPBroadcastDelivery | E2 | NM/TM | 0 . . . 1 | Provides IP multicast address and | |
| | | | | port number for reception of | |
| | | | | scene/layout descriptions and/or | |
| | | | | their updates, over the broadcast | |
| | | | | channel. | |
| | | | | Contains the following attributes: | |
| | | | | port | |
| | | | | address | |
| Port | A | NM/TM | 1 | Scene/layout descriptions and/or | unsignedInt |
| | | | | their update delivery UDP | |
| | | | | destination port number; delivery | |
| | | | | over Broadcast Channel. | |
| Address | A | NM/TM | 1 | Scene/layout descriptions and/or | string |
| | | | | their update delivery IP multicast | |
| | | | | address; delivery over Broadcast | |
| | | | | Channel. | |
| RequestURL | E2 | NM/TM | 0 . . . 1 | URL through which the terminal | anyURI |
| | | | | can subscribe to scene/layout | |
| | | | | descriptions and/or their updates; | |
| | | | | delivery over Interaction Channel. | |
| PollURL | E2 | NM/TM | 0 . . . 1 | URL through which the terminal | anyURI |
| | | | | can poll general scene/layout | |
| | | | | descriptions and/or their updates, | |
| | | | | over Interaction Channel. | |

After the RME metadata is incorporated in the service guide 201, the metadata service 109 initiates transmission of the service guide 201 to the UE 105 (step 305 of FIG. 3). In exemplary embodiments, the metadata is transmitted in a SGDD 223, in one or more fragments of a service guide, over an interaction channel, in one or more entry points of a broadcast channel, or any combination thereof.

FIG. 4 is a diagram of paths for transmitting a service guide to a user equipment, according to an exemplary embodiment. As shown, a UE 105 may receive the service guide containing RME metadata 401 from RME platform 101 and service platform 103 in several ways. For example, a UE 105 with access to an interaction channel 403 also supports mechanisms for accessing the service guide with RME metadata 401 according to specific provisions that govern delivery of the guide 401 over the interaction channel 403. Accordingly, the UE 105 follows a specified set of rules when requesting either service guide fragments or service guide delivery descriptors (SGDD) 223 over the interaction channel 403. Furthermore, when the UE 105 requests the service guide with RME metadata 401 as, for instance, an SVG scene description using “POST” method of HTTP/1.1, the UE 105 may specify the requested format of response. In one embodiment, the “message-body” of HTTP/1.1 request may be prefixed with “type=svg.” The response to this request may be a HTTP/1.1 response, delivering the SVG description of the service guide 401. In accordance with another embodiment, when the UE 105 requests the service guide 401 as a dynamically updated RME description using “POST” method of HTTP/1.1, the “message-body” of HTTP/1.1 request may be prefixed with “type=rme.” The response to this request may be a HTTP/1.1 response that may deliver the SDP-formatted session description, and may further give one or more access parameters to the RME session that carries one or more RME scene descriptions and/or one or more RME scene updates. In one embodiment, the response may already contain the first SVG scene description of the service guide 401.

When the service guide with RME metadata 401 is delivered using a broadcast channel 405, the UE 105 finds and accesses the broadcast IP flows that carry the broadcast service guide 401. According to the service guide framework, the service guide announcement channel is the starting point of this retrieval. For example, the service guide announcement channel provides the information to the UE 105 for retrieving the service guide. To discover the service guide 401, the UE 105 locates the file delivery session that carries the service guide announcement channel. The access parameters of the file delivery over unidirectional transport (FLUTE) session representing the service guide announcement channel are called the “entry points” to the service guide 401 on the broadcast channel 405.

When the service guide 401 is delivered over the interaction channel 403, the entry point may be defined as the URL to a file containing a Session Description, or an URL to a resource resolving to a Session Description, which describes the file distribution session carrying service guide announcement information and possibly the service guide 401. This file distribution session originates from the service guide generation function and service guide distribution function. The entry point to a service guide 401 on an interaction channel 403 may be either fixed, or provisioned to the UE 105, or provided out-of-band (e.g. through a public or private web site).

In the above description of the discovery of service guide with RME metadata 401 over the broadcast channel 405 or the interaction channel 403, an entry point specifies a FLUTE delivery session that carries a service guide bootstrap. In accordance with another embodiment, instead of having the bootstrap descriptions further point to one or more FLUTE-based service guide delivery sessions, a special bootstrap message may be used to give a pointer to one or more RME scene description and/or update sessions. In another embodiment, such bootstrap messages may carry the latest SVG scene description to speed up the rendering process.

When the service guide 401 is distributed over the interaction channel 403, the UE 105 acquires the discovery information and may send a request to acquire the service guide 401. According to the service guide framework, the entry point to the service guide acquisition over the interaction channel 403 may be a URL that indicates the location of the service guide 401 (e.g., <http://provider.com/serviceguide>). This address is used by the UE 105 to acquire the service guide data over the interaction channel 403.

There are several possible ways through which the UE 105 may acquire the entry point information. Specifically, the UE 105 may support one or more of the following two methods for acquiring such information. First, the entry point information may be provided using the “AlternativeAccessURL” element of the SGDD 223 fragment, and second, the entry point information may be provisioned to the UE 105 using a provisioning function. In the second method, the UE 105 may, for instance, support OMA BCAST management object parameter “/<X>/SGServerAddress/”. In accordance with an embodiment, for the case where the service guide is provided as RME scene descriptions/updates, the UE 105 may further support OMA BCAST management object parameter “/<X>/RMEServerAddress/”. The structure of “/<X>/RMEServerAddress/” may be the same as that of “/<X>/SGServerAddress/” with the operational difference that the RME server address may provide the RME scene description/update streams (instead of service guide fragments). Furthermore, the entry point information may be fixed in the UE 105 or provided out-of-band using, for example, wireless application protocol (WAP), SMS, MMS, Web page, user input, and the like.

The described processes and arrangement advantageously, according to certain embodiments, provide for an integrated rich media environment.

The processes described herein for providing an integrated rich media environment may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

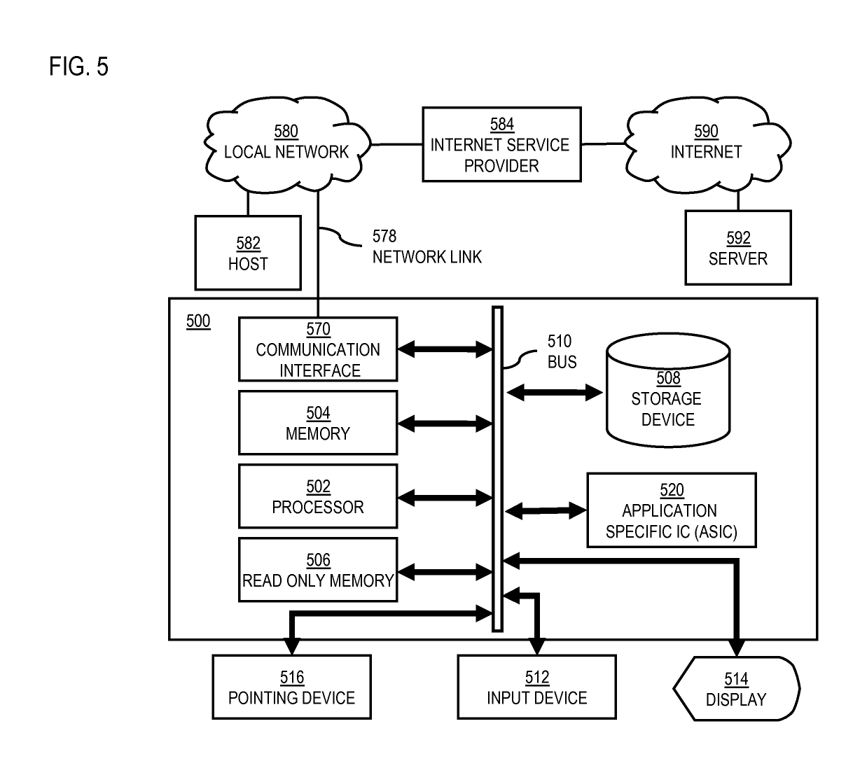

FIG. 5 illustrates a computer system 500 upon which an embodiment of the invention may be implemented. Computer system 500 is programmed to carry out the inventive functions described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information. The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

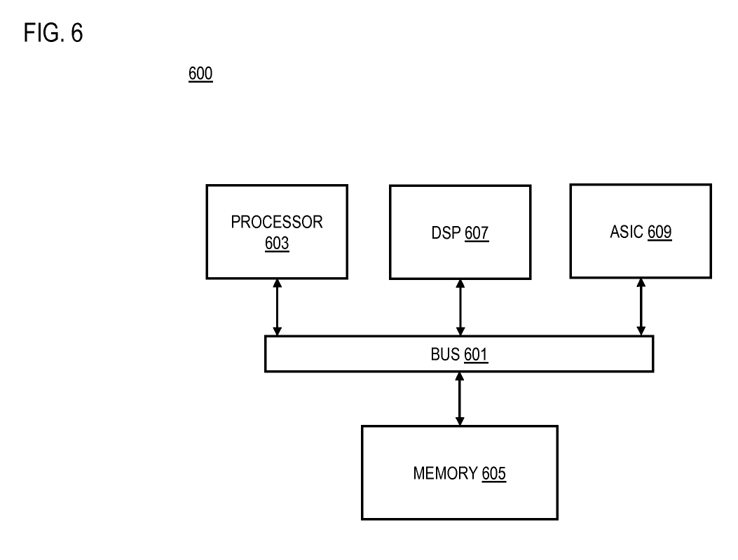

FIG. 6 illustrates a chip set 600 upon which an embodiment of the invention may be implemented. Chip set 600 is programmed to carry out the inventive functions described herein and includes, for instance, the processor and memory components described with respect to FIG. 5 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein. The memory 605 also stores the data associated with or generated by the execution of the inventive steps.

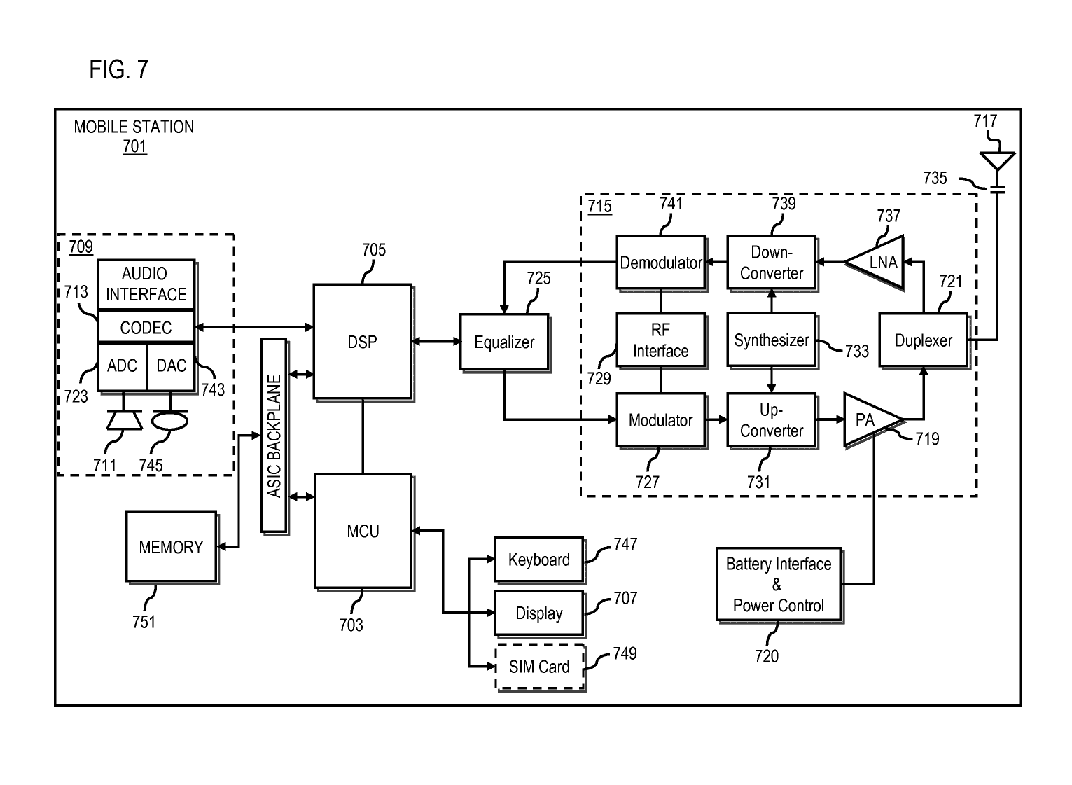

FIG. 7 is a diagram of exemplary components of a mobile station (e.g., handset) capable of operating in the system of FIG. 1, according to an exemplary embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The MCU 703 delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining to generate metadata relating to media content, the metadata including a parameter specifying rich media information; and
determining to incorporate the metadata into a service guide.

2. A method of claim 1, wherein the media content includes broadcast television programming, on-demand programming, pay-per-view programming, Internet-based programming, personalized content delivery, interactive programming, or any combination thereof.

3. A method of claim 1, further comprising:
determining to initiate transmission of the service guide to a user equipment.

4. A method of claim 3, wherein the user equipment is configured to access the media content and the rich media information over a wireless network.

5. A method of claim 3, wherein the metadata in the service guide is ignored by an incompatible user equipment.

6. A method of claim 1, wherein the metadata is transmitted in a service guide delivery descriptor using a bootstrap message, in one or more fragments of a service guide, over an interaction channel, in one or more entry points of a broadcast channel, or any combination thereof.

7. A method of claim 6, wherein the one or more fragments of a service guide include a service fragment, a schedule fragment, a content fragment, an access fragment, a session description fragment, a purchase item fragment, a purchase data fragment, a purchase channel fragment, a preview data fragment, an interactivity data fragment, a service guide delivery descriptor, or any combination thereof.

8. An apparatus comprising:
at least one processor; and
at least one memory including computer program code for one or more programs,
the at least one memory and the computer program code configured to, with the at least one processor, cause the apparatus to perform at least the following,
determine to generate metadata relating to media content, the metadata including a parameter specifying rich media information; and
determine to incorporate the metadata into a service guide.

9. An apparatus according to claim 8, wherein the media content includes broadcast television programming, on-demand programming, pay-per-view programming, Internet-based programming, personalized content delivery, interactive programming, or any combination thereof.

10. An apparatus of claim 8, wherein the apparatus is further caused to:
determine to initiate transmission of the service guide to a user equipment.

11. An apparatus of claim 10, wherein the user equipment is configured to access the media content and the rich media information over a wireless network.

12. An apparatus of claim 10, wherein the metadata in the service guide is ignored by an incompatible user equipment.

13. An apparatus of claim 8, wherein the metadata is transmitted in a service guide delivery descriptor using a bootstrap message, in one or more fragments of a service guide, over an interaction channel, in one or more entry points of a broadcast channel, or any combination thereof.

14. An apparatus of claim 13, wherein the one or more fragments of a service guide include a service fragment, a schedule fragment, a content fragment, an access fragment, a session description fragment, a purchase item fragment, a purchase data fragment, a purchase channel fragment, a preview data fragment, an interactivity data fragment, a service guide delivery descriptor, or any combination thereof.

15. A computer-readable storage medium carrying one or more sequences of one or more instructions which, when executed by one or more processors, cause an apparatus to at least perform the following steps:
determining to generate metadata relating to media content, the metadata including a parameter specifying rich media information; and
determining to incorporate the metadata into a service guide.

16. A computer readable storage medium of claim 15, wherein the media content includes broadcast television programming, on-demand programming, pay-per-view programming, Internet-based programming, personalized content delivery, interactive programming, or any combination thereof.

17. A computer readable storage medium of claim 15, wherein the one or more processors are caused to perform steps further comprising:
determining to initiate transmission of the service guide to a user equipment.

18. A computer readable storage medium of claim 17, wherein the user equipment is configured to access the media content and the rich media information over a wireless network.

19. A computer readable storage medium of claim 15, wherein the metadata is transmitted in a service guide delivery descriptor using a bootstrap message, in one or more fragments of a service guide, over an interaction channel, in one or more entry points of a broadcast channel, or any combination thereof.

20. A computer readable storage medium of claim 19, wherein the one or more fragments of a service guide include a service fragment, a schedule fragment, a content fragment, an access fragment, a session description fragment, a purchase item fragment, a purchase data fragment, a purchase channel fragment, a preview data fragment, an interactivity data fragment, a service guide delivery descriptor, or any combination thereof.
